(19) United States
(12) Patent Application Publication
(10) Pub. No.: US 2024/0414818 A1
(43) Pub. Date: Dec. 12, 2024

(54) LOAD CONTROL DEVICE FOR A LIGHT-EMITTING DIODE LIGHT SOURCE

(71) Applicant: Lutron Technology Company LLC, Coopersburg, PA (US)

(72) Inventor: Stuart W. DeJonge, Riegelsville, PA (US)

(73) Assignee: Lutron Technology Company LLC, Coopersburg, PA (US)

(21) Appl. No.: 18/812,181

(22) Filed: Aug. 22, 2024

Related U.S. Application Data
(63) Continuation of application No. 17/862,020, filed on Jul. 11, 2022, now Pat. No. 12,075,532.
Application No. 17/862,020 is a continuation of application No. 17/081,953, filed on Oct. 27, 2020, now Pat. No. 11,388,791.
Application No. 17/081,953 is a continuation of application No. 16/595,970, filed on Oct. 8, 2019, now Pat. No. 10,827,577.
Application No. 16/595,970 is a continuation of application No. 16/219,428, filed on Dec. 13, 2018, now Pat. No. 10,455,659.
Application No. 16/219,428 is a continuation of application No. 15/857,271, filed on Dec. 28, 2017, now Pat. No. 10,194,501.
Application No. 15/857,271 is a continuation of application No. 15/399,694, filed on Jan. 5, 2017, now Pat. No. 9,888,540.
Application No. 15/399,694 is a continuation of application No. 15/142,876, filed on Apr. 29, 2016, now Pat. No. 9,565,731.
(60) Provisional application No. 62/155,871, filed on May 1, 2015.

(51) Int. Cl. H05B 45/14; H02M 3/335; H05B 45/10; H05B 45/327; H05B 45/382; H05B 45/39

(52) U.S. Cl. CPC H05B 45/14; H02M 3/33507; H05B 45/327; H05B 45/382; H05B 45/39; H05B 45/10

(57) ABSTRACT

A load control device for controlling the amount of power delivered to an electrical load is able to operate in a normal mode and a burst mode. The load control device may comprise a control circuit that activates an inverter circuit during active state periods and deactivates the inverter circuit during inactive state periods. The control circuit may operate in the normal mode to regulate an average magnitude of a load current conducted through the electrical load to be above a minimum rated current. The control circuit may operate in the burst mode to adjust the average magnitude of the load current to be below the minimum rated current. The control circuit may adjust the average magnitude of the load current by adjusting the length of the inactive state periods while holding the length of the active state periods constant.

### CROSS REFERENCE TO RELATED APPLICATION

This application is a continuation of U.S. patent application Ser. No. 17/862,020, filed Jul. 11, 2022; which is a continuation of U.S. patent application Ser. No. 17/081,953, filed Oct. 27, 2020, now U.S. Pat. No. 11,388,791 issued Jul. 12, 2022; which is a continuation of U.S. patent application Ser. No. 16/595,970, filed Oct. 8, 2019, now U.S. Pat. No. 10,827,577 issued Nov. 3, 2020; which is a continuation of U.S. patent application Ser. No. 16/219,428, filed Dec. 13, 2018, now U.S. Pat. No. 10,455,659, issued Oct. 22, 2019; which is a continuation of U.S. patent application Ser. No. 15/857,271, filed Dec. 28, 2017, now U.S. Pat. No. 10,194,501 issued Jan. 29, 2019; which is a continuation of U.S. patent application Ser. No. 15/399,694, filed Jan. 5, 2017, now U.S. Pat. No. 9,888,540 issued Feb. 6, 2018; which is a continuation of U.S. patent application Ser. No. 15/142,876, filed Apr. 29, 2016, now U.S. Pat. No. 9,565,731 issued Feb. 7, 2017; which claims the benefit of Provisional U.S. Patent Application No. 62/155,871, filed May 1, 2015, the disclosures of which are incorporated herein by reference in their entireties.

### BACKGROUND

Light-emitting diode (LED) light sources (e.g., LED light engines) are often used in place of or as replacements for conventional incandescent, fluorescent, or halogen lamps, and the like. LED light sources may comprise a plurality of light-emitting diodes mounted on a single structure and provided in a suitable housing. LED light sources are typically more efficient and provide longer operational lives as compared to incandescent, fluorescent, and halogen lamps. An LED driver control device (e.g., an LED driver) may be coupled between an alternating-current (AC) power source and an LED light source for regulating the power supplied to the LED light source. The LED driver may regulate either the voltage provided to the LED light source to a particular value, the current supplied to the LED light source to a specific current value, or may regulate both the current and voltage.

LED light sources are typically rated to be driven via one of two different control techniques: a current load control technique or a voltage load control technique. An LED light source that is rated for the current load control technique is also characterized by a rated current (e.g., approximately 350 milliamps) to which the peak magnitude of the current through the LED light source should be regulated to ensure that the LED light source is illuminated to the appropriate intensity and color. In contrast, an LED light source that is rated for the voltage load control technique is characterized by a rated voltage (e.g., approximately 15 volts) to which the voltage across the LED light source should be regulated to ensure proper operation of the LED light source. If an LED light source rated for the voltage load control technique includes multiple parallel strings of LEDs, a current balance regulation element may be used to ensure that each of the parallel strings has the same impedance so that the same current is drawn in each parallel string.

The light output of an LED light source can be dimmed. Methods of dimming LEDs include a pulse-width modulation (PWM) technique and a constant current reduction (CCR) technique, for example. Pulse-width modulation dimming can be used for LED light sources that are controlled in either a current load control mode/technique or a voltage load control mode/technique. In pulse-width modulation dimming, a pulsed signal with a varying duty cycle is supplied to the LED light source. If the LED light source is being controlled using the current load control technique, the peak current supplied to the LED light source is kept constant during an on time of the duty cycle of the pulsed signal. However, as the duty cycle of the pulsed signal varies, the average current supplied to the LED light source also varies, thereby varying the intensity of the light output of the LED light source. If the LED light source is being controlled using the voltage load control technique, the voltage supplied to the LED light source is kept constant during the on time of the duty cycle of the pulsed signal in order to achieve the desired target voltage level, and the duty cycle of the load voltage is varied in order to adjust the intensity of the light output. Constant current reduction dimming is typically used when an LED light source is being controlled using the current load control technique. In constant current reduction dimming, current is continuously provided to the LED light source. The DC magnitude of the current provided to the LED light source, however, is varied to thus adjust the intensity of the light output. Examples of LED drivers are described in greater detail in commonly-assigned U.S. Pat. No. 8,492,987, issued Jul. 23, 2010, and U.S. Patent Application Publication No. 2013/0063047, published Mar. 14, 2013, both entitled LOAD CONTROL DEVICE FOR A LIGHT-EMITTING DIODE LIGHT SOURCE, the entire disclosures of which are hereby incorporated by reference.

Dimming an LED light source using traditional techniques may result in changes in light intensity that are perceptible to the human vision. This problem may be more apparent if the dimming occurs while the LED light source is near the low end of its intensity range (e.g., below 5% of a maximum intensity). Accordingly, methods and apparatus for fine tuning the intensity of an LED light source may be desirable.

### SUMMARY

As described herein, a load control device for controlling a load current conducted through an electrical load may comprise a load regulation circuit and a control circuit. The load regulation circuit may be configured to control the magnitude of a load current conducted through the electrical load in order to control the amount of power delivered to the electrical load. The load regulation circuit may comprise a switching device. The switching device may be controlled by the control circuit to operate in an active state during active state periods and in an inactive state during inactive state periods. The control circuit may be configured to operate in a normal mode and a burst mode, and to control the average magnitude of the load current towards a target load current. The normal mode may be applied when the target load current is between a maximum rated current and a minimum rated current. The burst mode may be applied when the target load current is below the minimum rated current. Further, the burst mode may be characterized by a plurality of burst mode periods each comprising one of the active state periods and one of the inactive state periods.

During the normal mode, the control circuit may be configured to regulate the average magnitude of the load current by driving the switching device between different operating states to regulate the average magnitude of the load current. The different operating states may comprise a conductive state and a non-conductive state, for example. During the burst mode, the control circuit may be configured to adjust the average magnitude of the load current by driving the switching device between the different operating states during the active state periods and stopping driving the switching device between the different operating states during the inactive state periods. The control circuit may be configured to adjust the average magnitude of the load current by adjusting the lengths of the inactive state periods and/or the active state periods. The control circuit may be configured to adjust the length of the inactive state periods in one or more of the burst mode periods while holding the length of the active state periods constant (e.g., until a maximum amount of adjustment has been made to the length of inactive state periods). The one or more burst mode periods may be adjacent to each other or may be separated by another burst mode period (or a plurality of burst mode periods). The control circuit may be configured to adjust the length of the active state periods and the length of the inactive state periods in a succeeding burst mode period. The control circuit may repeat the foregoing adjustment steps if further adjustment is desired. The amounts of adjustment made to the lengths of the inactive state periods and the active state periods may be determined such that fine tuning of the load current may be achieved. The determination may be made in real time or based on data stored in memory.

Also described herein are methods for controlling a load current conducted through an electrical load. The control may be applied in different operating modes including a normal mode and a burst mode. During the normal mode, an average magnitude of the load current may be regulated towards a target current by driving a switching device between different operating states. For example, the switching device may be driven between a conductive state and a non-conductive state to regulate the average magnitude of the load current towards the target current. During the burst mode, the average magnitude of the load current may be adjusted to the target current over a plurality of burst mode periods. Each of the burst mode periods may include an active state period and an inactive state period. The switching device may be driven between the different operating states during the active state period of each of the plurality of burst mode periods. The switching device may not be driven between the different operating states during the inactive state period of each of the plurality of burst mode periods. The length of the inactive state period may be adjusted in at least a subset of the plurality of burst mode periods while the length of the active state period may be held constant. The length of the active state period may also be adjusted, for example, by an active state adjustment amount in at least one of the plurality of burst mode periods. The length of the inactive state period may be adjusted until a total amount of adjustment is equal to approximately a threshold amount before the length of the active state period is adjusted.

### BRIEF DESCRIPTION OF THE DRAWINGS

FIG. 1 is a simplified block diagram of a light-emitting diode (LED) driver for controlling the intensity of an LED light source.

FIG. 2 is an example plot of a target load current of the LED driver of FIG. 1 as a function of a target intensity.

FIG. 3 is an example plot of a burst duty cycle of the LED driver of FIG. 1 as a function of the target intensity.

FIG. 4 is an example state diagram illustrating the operation of a load regulation circuit of the LED driver of FIG. 1 when operating in a burst mode.

FIG. 5 is a simplified schematic diagram of an isolated forward converter and a current sense circuit of an LED driver.

FIG. 6 is an example diagram illustrating a magnetic core set of an energy-storage inductor of a forward converter.

FIG. 7 shows example waveforms illustrating the operation of a forward converter and a current sense circuit when the intensity of an LED light source is near a high-end intensity.

FIG. 8 shows example waveforms illustrating the operation of a forward converter and a current sense circuit when the intensity of an LED light source is near a low-end intensity.

FIG. 9 shows example waveforms illustrating the operation of a forward converter of an LED driver when operating in a burst mode.

FIG. 10 is a diagram of an example waveform illustrating a load current when a load regulation circuit is operating in a burst mode.

FIG. 11 is an example plot showing how a relative average light level may change as a function of the number of inverter cycles included in an active state period when a load regulation circuit is operating in a burst mode.

FIG. 12 shows example waveforms illustrating a load current when a load regulation circuit of an LED driver is operating in a burst mode.

FIG. 13 is an example of a plot relationship between a target load current and the lengths of an active state period and an inactive state period when a load regulation circuit of an LED driver is operating in a burst mode.

FIG. 14 is a simplified flowchart of an example procedure for operating a forward converter of an LED driver in a normal mode and a burst mode.

### DETAILED DESCRIPTION

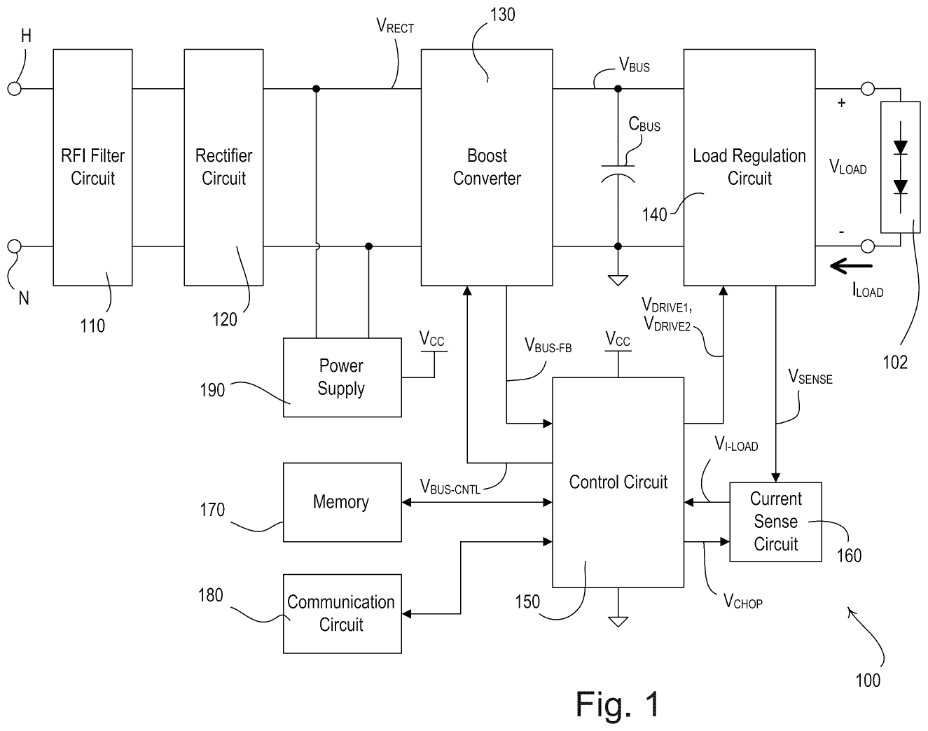

FIG. 1 is a simplified block diagram of a load control device, e.g., a light-emitting diode (LED) driver 100, for controlling the amount of power delivered to an electrical load, such as, an LED light source 102 (e.g., an LED light engine), and thus the intensity of the electrical load. The LED light source 102 is shown as a plurality of LEDs connected in series but may comprise a single LED or a plurality of LEDs connected in parallel or a suitable combination thereof, depending on the particular lighting system. The LED light source 102 may comprise one or more organic light-emitting diodes (OLEDs). The LED driver 100 may comprise a hot terminal H and a neutral N. The terminals may be adapted to be coupled to an alternating-current (AC) power source (not shown).

The LED driver 100 may comprise a radio-frequency interference (RFI) filter circuit 110, a rectifier circuit 120, a boost converter 130, a load regulation circuit 140, a control circuit 150, a current sense circuit 160, a memory 170, a communication circuit 180, and/or a power supply 190. The RFI filter circuit 110 may minimize the noise provided on the AC mains. The rectifier circuit 120 may generate a rectified voltage VRECT.

The boost converter 130 may receive the rectified voltage VRECT and generate a boosted direct-current (DC) bus voltage V_{BUS} across a bus capacitor CBUS. The boost converter 130 may comprise any suitable power converter circuit for generating an appropriate bus voltage, such as, for example, a flyback converter, a single-ended primary-inductor converter (SEPIC), a Ćuk converter, or other suitable power converter circuit. The boost converter 130 may operate as a power factor correction (PFC) circuit to adjust the power factor of the LED driver 100 towards a power factor of one.

The load regulation circuit 140 may receive the bus voltage V_{BUS} and control the amount of power delivered to the LED light source 102, for example, to control the intensity of the LED light source 102 between a high-end (e.g., maximum) intensity L_{HE} (e.g., approximately 100%) and a low-end (e.g., minimum) intensity L_{LE} (e.g., approximately 1-5% of the high-end intensity). An example of the load regulation circuit 140 may be an isolated, half-bridge forward converter. An example of the load control device (e.g., LED driver 100) comprising a forward converter is described in greater detail in commonly-assigned U.S. patent application Ser. No. 13/935,799, filed Jul. 5, 2013, entitled LOAD CONTROL DEVICE FOR A LIGHT-EMITTING DIODE LIGHT SOURCE, the entire disclosure of which is hereby incorporated by reference. The load regulation circuit 140 may comprise, for example, a buck converter, a linear regulator, or any suitable LED drive circuit for adjusting the intensity of the LED light source 102.

The control circuit 150 may be configured to control the operation of the boost converter 130 and/or the load regulation circuit 140. An example of the control circuit 150 may be a controller. The control circuit 150 may comprise, for example, a digital controller or any other suitable processing device, such as, for example, a microcontroller, a programmable logic device (PLD), a microprocessor, an application specific integrated circuit (ASIC), or a field-programmable gate array (FPGA). The control circuit 150 may generate a bus voltage control signal V_{BUS-CNTL}, which may be provided to the boost converter 130 for adjusting the magnitude of the bus voltage V_{BUS}. The control circuit 150 may receive a bus voltage feedback control signal V_{BUS-FB} from the boost converter 130, which may indicate the magnitude of the bus voltage V_{BUS}.

The control circuit 150 may generate drive control signals V_{DRIVE1}, V_{DRIVE2}. The drive control signals V_{DRIVE1}, V_{DRIVE2} may be provided to the load regulation circuit 140 for adjusting the magnitude of a load voltage V_{LOAD} generated across the LED light source 102 and/or the magnitude of a load current I_{LOAD} conducted through the LED light source 120. By controlling the load voltage V_{LOAD} and/or the load current I_{LOAD}, the control circuit may control the intensity of the LED light source 120 to a target intensity L_{TRGT}. The control circuit 150 may adjust an operating frequency fop and/or a duty cycle DC_{INV} (e.g., an on time T_{ON}) of the drive control signals V_{DRIVE1}, V_{DRIVE2} in order to adjust the magnitude of the load voltage V_{LOAD} and/or the load current I_{LOAD}.

The current sense circuit 160 may receive a sense voltage V_{SENSE}. The sense voltage V_{SENSE} may be generated by the load regulation circuit 140. The sense voltage V_{SENSE} may indicate the magnitude of the load current I_{LOAD}. The current sense circuit 160 may receive a signal-chopper control signal V_{CHOP} from the control circuit 150. The current sense circuit 160 may generate a load current feedback signal V_{I-LOAD}, which may be a DC voltage indicating the average magnitude I_{AVE} of the load current I_{LOAD}. The control circuit 150 may receive the load current feedback signal V_{I-LOAD} from the current sense circuit 160. The control circuit 150 may adjust the drive control signals V_{DRIVE1}, V_{DRIVE2} based on the load current feedback signal V_{I-LOAD} so that the magnitude of the load current I_{LOAD} may be adjusted towards a target load current I_{TRGT}. For example, the control circuit 150 may set initial operating parameters for the drive control signals V_{DRIVE1}, V_{DRIVE2} (e.g., the operating frequency for and/or the duty cycle DC_{INV}). The control circuit 150 may receive the load current feedback signal V_{I-LOAD} indicating the effect of the drive control signals V_{DRIVE1}, V_{DRIVE2}. Based on the indication, the control circuit 150 may adjust the operating parameters of the drive control signals V_{DRIVE1}, V_{DRIVE2} to thus adjust the magnitude of the load current I_{LOAD} towards a target load current I_{TRGT} (e.g., using a control loop).

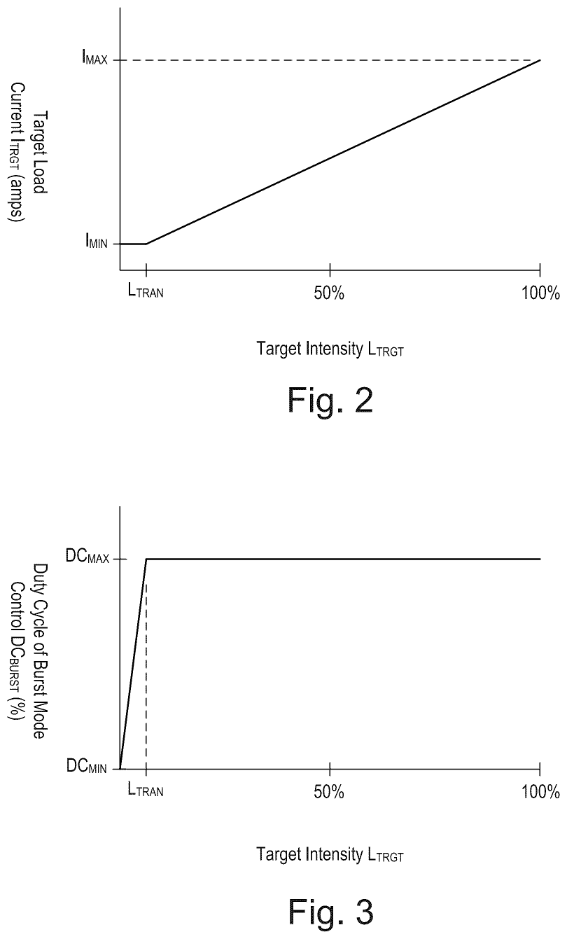

The load current I_{LOAD} may be the current that is conducted through the LED light source 120. The target load current I_{TRGT} may be the current that the control circuit 150 aims to conduct through the LED light source 120 (e.g., based at least on the load current feedback signal V_{I-LOAD}). The load current I_{LOAD} may be approximately equal to the target load current I_{TRGT} but may not always match the target load current I_{TRGT}. This may be because, for example, the control circuit 150 may have specific levels of granularity in which it can control the current conducted through the LED light source 120 (e.g., due to inverter cycle lengths, etc.). A person skilled in the art will appreciate that the figures shown herein (e.g., FIG. 2) that illustrate the current conducted through an LED light source as a linear graph (at least in parts) may represent the target load current I_{TRGT}, since the load current I_{LOAD} itself may not be exactly equal to the target load current I_{TRGT} and may not actually follow a true linear path.

The control circuit 150 may be coupled to the memory 170. The memory 170 may store operational characteristics of the LED driver 100 (e.g., the target intensity L_{TRGT}, the low-end intensity L_{LE}, the high-end intensity L_{HE}, etc.). The communication circuit 180 may be coupled to, for example, a wired communication link or a wireless communication link, such as a radio-frequency (RF) communication link or an infrared (IR) communication link. The control circuit 150 may be configured to update the target intensity L_{TRGT} of the LED light source 102 and/or the operational characteristics stored in the memory 170 in response to digital messages received via the communication circuit 180. The LED driver 100 may be operable to receive a phase-control signal from a dimmer switch for determining the target intensity L_{TRGT} for the LED light source 102. The power supply 190 may receive the rectified voltage VRECT and generate a direct-current (DC) supply voltage V_{CC} for powering the circuitry of the LED driver 100.

FIG. 2 is an example plot of the target load current I_{TRGT} as a function of the target intensity L_{TRGT}. As shown, a linear relationship may exist between the target intensity L_{TRGT} and the target load current I_{TRGT}. That is, to achieve a higher target intensity, the control circuit 150 may increase the target load current I_{TRGT} in proportion to the increase in the target intensity; to achieve a lower target intensity, the control circuit 150 may decrease the target load current I_{TRGT} in proportion to the decrease in the target intensity. As the target load current I_{TRGT} is being adjusted, the magnitude of the load current I_{LOAD} may change accordingly. There may be limits, however, to how much the load current I_{LOAD} may be adjusted. For example, the load current I_{LOAD} may not be adjusted above a maximum rated current I_{MAX} or below a minimum rated current I_{MIN} (e.g., due to hardware limitations of the load regulation circuit 140 and/or the control circuit 150). Thus, the control circuit may be configured to adjust the target load current I_{TRGT} between the maximum rated current I_{MAX} and the minimum rated current I_{MIN} so that the magnitude of the load current I_{LOAD} may fall into in the same range. The maximum rated current I_{MAX} may correspond to the high-end intensity L_{HE} (e.g., approximately 100%). The minimum rated current I_{MIN} may correspond to a transition intensity L_{TRAN} (e.g., approximately 5% of the maximum intensity). Between the high-end intensity L_{HE} and the transition intensity L_{TRAN}, the control circuit 150 may operate the load regulation circuit 140 in a normal mode in which an average magnitude I_{AVE} of the load current I_{LOAD} may be controlled to be equal to (e.g., approximately equal to) the target load current I_{TRGT}. During the normal mode, the control circuit 150 may adjust the average magnitude I_{AVE} of the load current I_{LOAD} to the target load current I_{TRGT} in response to the load current feedback signal V_{I-LOAD} (e.g., using closed loop control), for example. The control circuit 150 may apply various control techniques during the normal mode including, for example, a pulse-width modulation technique or a constant current reduction technique.

To adjust the average magnitude I_{AVE} of the load current I_{LOAD} to below the minimum rated current I_{MIN} (and to thus adjust the target intensity L_{TRGT} below the transition intensity L_{TRAN}), the control circuit 150 may be configured to operate the load regulation circuit 140 in a burst mode. The burst mode may be characterized by a burst operating period that includes an active state period and an inactive state period. During the active state period, the control circuit 150 may be configured to regulate the load current I_{LOAD} in ways similar to those in the normal mode. During the inactive state period, the control circuit 150 may be configured to stop regulating the load current I_{LOAD} (e.g., to allow the load current I_{LOAD} to drop to approximately zero). Although the active state and inactive state periods are described herein in association with the burst mode, a person skilled in the art will understand that the normal mode may also be characterized by an operating period that includes the active state period and the inactive state period, e.g., with both periods held constant and the inactive state period held at approximately zero. Examples of a load control device capable of operating in a burst mode and a normal mode are described in greater detail in commonly-assigned U.S. Pat. No. 9,247,608, issued Jan. 26, 2016, entitled LOAD CONTROL DEVICE FOR A LIGHT-EMITTING DIODE LIGHT SOURCE, the entire disclosure of which is hereby incorporated by reference.

The ratio of the active state period to the burst operating period, e.g., T_{ACTIVE}/T_{BURST}, may represent a burst duty cycle DC_{BURST}. The burst duty cycle DC_{BURST} may be controlled, for example, between a maximum duty cycle DC_{MAX} (e.g., approximately 100%) and a minimum duty cycle DC_{MIN} (e.g., approximately 20%). The load current I_{LOAD} may be adjusted towards the target current I_{TRGT} (e.g., the minimum rated current I_{MIN}) during the active state period of the burst mode. Setting the burst duty cycle DC_{BURST} to a value less than the maximum duty cycle DC_{MAX} may reduce the average magnitude I_{AVE} of the load current I_{LOAD} to below the minimum rated current I_{MIN}.

FIG. 3 is an example plot of a burst duty cycle DC_{BURST} (e.g., an ideal burst duty cycle DC_{BURST-IDEAL}) as a function of the target intensity L_{TRGT}. As described herein, when the target intensity L_{TRGT} is between the high-end intensity L_{HE} (e.g., approximately 100%) and a transition intensity L_{TRAN} (e.g., approximately 5% of the maximum intensity), the control circuit 150 may be configured to operate the load regulation circuit 140 in the normal mode, e.g., by setting the burst duty cycle DC_{BURST} to a maximum duty cycle DC_{MAX} or approximately 100%. To adjust the target intensity L_{TRGT} below the transition intensity L_{TRAN}, the control circuit 150 may be configured to operate the load regulation circuit 140 in the burst mode, e.g., by adjusting the burst duty cycle DC_{BURST} between the maximum duty cycle DC_{MAX} (e.g., approximately 100%) and a minimum duty cycle DC_{MIN} (e.g., approximately 20%). In the burst mode, a peak magnitude I_{PK} of the load current I_{LOAD} may be equal to the target current I_{TRGT} (e.g., the minimum rated current I_{MIN}) during an active state period of the burst mode.

With reference to FIG. 3, the burst duty cycle DC_{BURST} may refer to an ideal burst duty cycle DC_{BURST-IDEAL}, which may include an integer portion DC_{BURST-INTEGER} and/or a fractional portion DC_{BURST-FRACTIONAL}. The integer portion DC_{BURST-INTEGER} may be characterized by the percentage of the ideal burst duty cycle DC_{BURST-IDEAL} that includes complete inverter cycles (i.e., an integer value of inverter cycles). The fractional portion DC_{BURST-FRACTIONAL} may be characterized by the percentage of the ideal burst duty cycle DC_{BURST-IDEAL} that includes a fraction of an inverter cycle. In at least some cases, the control circuit 150 (e.g., via the load regulation circuit 140) may be configured to adjust the number of inverter cycles by an integer number (e.g., by DC_{BURST-INTEGER}) and not a fractional amount (e.g., DC_{BURST-FRACTIONAL}). Therefore, although the example plot of FIG. 3 illustrates an ideal curve showing continuous adjustment of the ideal burst duty cycle DC_{BURST-IDEAL} from a maximum duty cycle DC_{MAX} to a minimum duty cycle DC_{MIN}, unless defined differently, burst duty cycle DC_{BURST} may refer to the integer portion DC_{BURST-INTEGER} of the ideal burst duty cycle DC_{BURST-IDEAL} (e.g., if the control circuit 150 is not be configured to operate the burst duty cycle DC_{BURST} at fractional amounts).

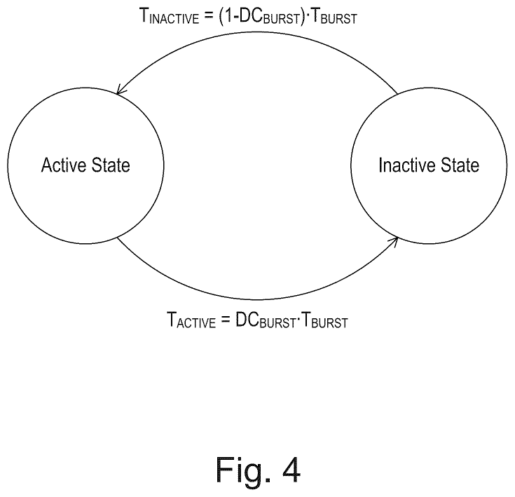

FIG. 4 is an example state diagram illustrating the operation of the load regulation circuit 140 in the burst mode. During the burst mode, the control circuit 150 may periodically control the load regulation circuit 140 into an active state and an inactive state, e.g., in dependence upon a burst duty cycle DC_{BURST} and a burst mode period T_{BURST} (e.g., approximately 4.4 milliseconds). For example, the active state period (T_{ACTIVE}) may be equal to the burst duty cycle (DC_{BURST}) times the burst mode period (T_{BURST}) and the inactive state period (T_{INACTIVE}) may be equal to one minus the burst duty cycle (DC_{BURST}) times the burst mode period (T_{BURST}). That is, T_{ACTIVE}=DC_{BURST}·T_{BURST} and T_{INACTIVE}=(1−DC_{BURST})·T_{BURST}.

In the active state of the burst mode, the control circuit 150 may be configured to generate the drive control signals V_{DRIVE1}, V_{DRIVE2}. The control circuit 150 may be further configured to adjust the operating frequency for and/or the duty cycle DC_{INV} (e.g., an on time T_{ON}) of the drive control signals V_{DRIVE1}, V_{DRIVE2} in order to adjust the magnitude of the load current I_{LOAD}. The control circuit 150 may be configured to make the adjustments using closed loop control. For example, in the active state of the burst mode, the control circuit 150 may generate the drive signals V_{DRIVE1}, V_{DRIVE2} to adjust the magnitude of the load current I_{LOAD} to be equal to a target load current I_{TRGT} (e.g., the minimum rated current I_{MIN}) in response to the load current feedback signal V_{I-LOAD}.

In the inactive state of the burst mode, the control circuit 150 may let the magnitude of the load current I_{LOAD} drop to approximately zero amps, e.g., by freezing the control loop and/or not generating the drive control signals V_{DRIVE1}, V_{DRIVE2}. While the control loop is frozen (e.g., in the inactive state), the control circuit 150 may stop responding to the load current feedback signal V_{I-LOAD} (e.g., the control circuit 150 may not adjust the values of the operating frequency fop and/or the duty cycle DC_{INV} in response to the feedback signal). The control circuit 150 may store the present duty cycle DC_{INV} (e.g., the present on time T_{ON}) of the drive control signals V_{DRIVE1}, V_{DRIVE2} in the memory 170 prior to (e.g., immediately prior to) freezing the control loop. When the control loop is unfrozen (e.g., when the control circuit 150 enters the active state), the control circuit 150 may resuming generating the drive control signals V_{DRIVE1}, V_{DRIVE2} using the operating frequency fop and/or the duty cycle DC_{INV} from the previous active state.

The control circuit 150 may be configured to adjust the burst duty cycle DC_{BURST} using an open loop control. For example, the control circuit 150 may be configured to adjust the burst duty cycle DC_{BURST} as a function of the target intensity L_{TRGT} when the target intensity L_{TRGT} is below the transition intensity L_{TRAN}. For example, the control circuit 150 may be configured to linearly decrease the burst duty cycle DC_{BURST} as the target intensity L_{TRGT} is decreased below the transition intensity L_{TRAN} (e.g., as shown in FIG. 3), while the target load current I_{TRGT} is held constant at the minimum rated current I_{MIN} (e.g., as shown in FIG. 2). Since the control circuit 150 changes between the active state and the inactive state in dependence upon the burst duty cycle DC_{BURST} and the burst mode period T_{BURST} (e.g., as shown in the state diagram of FIG. 4), the average magnitude I_{AVE} of the load current I_{LOAD} may be a function of the burst duty cycle DC_{BURST} (e.g., I_{AVE}=DC_{BURST}. I_{MIN}). During the burst mode, the peak magnitude I_{PK} of the load current I_{LOAD} may be equal to the minimum rated current I_{MIN}, but the average magnitude I_{AVE} of the load current I_{LOAD} may be less than the minimum rated current I_{MIN}.

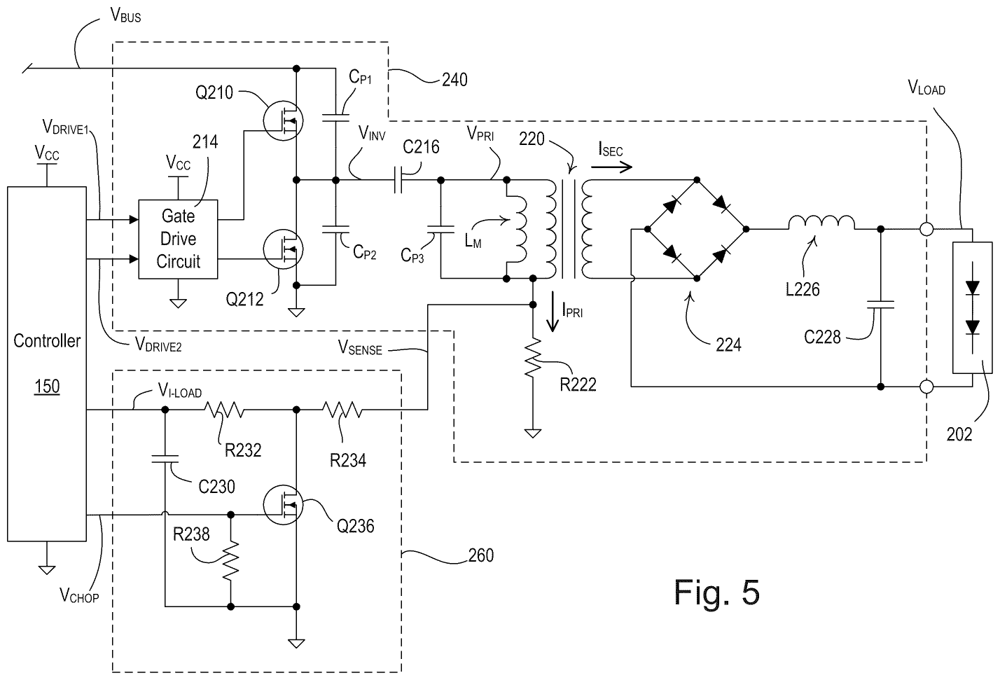

FIG. 5 is a simplified schematic diagram of a forward converter 240 and a current sense circuit 260 of an LED driver (e.g., the LED driver 100 shown in FIG. 1). The forward converter 240 may be an example of the load regulation circuit 140 of the LED driver 100 shown in FIG. 1. The current sense circuit 260 may be an example of the current sense circuit 160 of the LED driver 100 shown in FIG. 1.

The forward converter 240 may comprise a half-bridge inverter circuit having two field effect transistors (FETs) Q210, Q212 for generating a high-frequency inverter voltage V_{INV} from the bus voltage V_{BUS}. The FETs Q210, Q212 may be rendered conductive and non-conductive in response to the drive control signals V_{DRIVE1}, V_{DRIVE2}. The drive control signals V_{DRIVE1}, V_{DRIVE2} may be received from the control circuit 150. The drive control signals V_{DRIVE1}, V_{DRIVE2} may be coupled to the gates of the respective FETs Q210, Q212 via a gate drive circuit 214 (e.g., which may comprise part number L6382DTR, manufactured by ST Microelectronics). The control circuit 150 may be configured to generate the inverter voltage V_{INV} at an operating frequency fop (e.g., approximately 60-65 kHz) and thus an operating period Top. The control circuit 150 may be configured to adjust the operating frequency fop under certain operating conditions. The control circuit 150 may be configured to adjust a duty cycle DC_{INV} of the inverter voltage V_{INV} to control the intensity of an LED light source 202 towards the target intensity L_{TRGT}.

In a normal mode of operation, when the target intensity L_{TRGT} of the LED light source 202 is between the high-end intensity L_{HE} and the transition intensity L_{TRAN}, the control circuit 150 may adjust the duty cycle DC_{INV} of the inverter voltage V_{INV} to adjust the magnitude (e.g., the average magnitude I_{AVE}) of the load current I_{LOAD} towards the target load current I_{TRGT}. As described herein, the magnitude of the load current I_{LOAD} may vary between the maximum rated current I_{MAX} and the minimum rated current I_{MIN} (e.g., as shown in FIG. 2). At the minimum rated current I_{MIN} and/or the transition intensity L_{TRAN}, the inverter voltage V_{INV} may be characterized by a transition (e.g., from a normal mode to a burst mode) operating frequency f_{OP-T}, a transition operating period T_{OP-T}, and a transition duty cycle DC_{INV-T}.

When the target intensity L_{TRGT} of the LED light source 202 is below the transition intensity L_{TRAN}, the control circuit 150 may be configured to operate the forward converter 240 in a burst mode of operation. In addition to or in lieu of using target intensity as a threshold for determining when to operate in the burst mode, the control circuit 150 may use power (e.g., a transition power) and/or current (e.g., a transition current) as the threshold. In the burst mode of operation, the control circuit 150 may be configured to switch the forward converter 240 between an active state (e.g., in which the control circuit 150 may actively generate the drive control signals V_{DRIVE1}, V_{DRIVE2} to regulate the peak magnitude I_{PK} of the load current I_{LOAD} to be equal to the minimum rated current I_{MIN}) and an inactive state (e.g., in which the control circuit 150 may freeze the control loop and does not generate the drive control signals V_{DRIVE1}, V_{DRIVE2}). FIG. 4 shows a state diagram illustrating the transmission between the two states. The control circuit 150 may change the forward converter 240 between the active state and the inactive state in dependence upon a burst duty cycle DC_{BURST} and a burst mode period T_{BURST} (e.g., as shown in FIG. 4). The control circuit 150 may adjust the burst duty cycle DC_{BURST} as a function of the target intensity L_{TRGT}, which is below the transition intensity L_{TRAN} (e.g., as shown in FIG. 3). In the active state of the burst mode (as well as in the normal mode), the forward converter 240 may be characterized by a turn-on time T_{TURN-ON} and a turn-off time T_{TURN-OFF}. The turn-on time T_{TURN-ON} may be a time period from when the drive control signals V_{DRIVE1}, V_{DRIVE2} are driven until the respective FET Q210, Q212 is rendered conductive. The turn-off time T_{TURN-OFF} may be a time period from when the drive control signals V_{DRIVE1}, V_{DRIVE2} are driven until the respective FET Q210, Q212 is rendered non-conductive.

The inverter voltage V_{INV} may be coupled to the primary winding of a transformer 220 through a DC-blocking capacitor C216 (e.g., which may have a capacitance of approximately 0.047 μF). A primary voltage V_{PRI} may be generated across the primary winding. The transformer 220 may be characterized by a turns ratio n_{TURNS} (e.g., N₁/N₂), which may be approximately 115:29. A sense voltage V_{SENSE} may be generated across a sense resistor R222, which may be coupled in series with the primary winding of the transformer 220. The FETs Q210, Q212 and the primary winding of the transformer 220 may be characterized by parasitic capacitances C_{P1}, C_{P2}, C_{P3}, respectively. The secondary winding of the transformer 220 may generate a secondary voltage. The secondary voltage may be coupled to the AC terminals of a full-wave diode rectifier bridge 224 for rectifying the secondary voltage generated across the secondary winding. The positive DC terminal of the rectifier bridge 224 may be coupled to the LED light source 202 through an output energy-storage inductor L226 (e.g., which may have an inductance of approximately 10 mH). The load voltage V_{LOAD} may be generated across an output capacitor C228 (e.g., which may have a capacitance of approximately 3 μF).

The current sense circuit 260 may comprise an averaging circuit for producing the load current feedback signal V_{I-LOAD}. The averaging circuit may comprise a low-pass filter comprising a capacitor C230 (e.g., which may have a capacitance of approximately 0.066 μF) and a resistor R232 (e.g., which may have a resistance of approximately 3.32 kΩ). The low-pass filter may receive the sense voltage V_{SENSE} via a resistor R234 (e.g., which may have a resistance of approximately 1 kΩ). The current sense circuit 160 may comprise a transistor Q236 (e.g., a FET as shown in FIG. 5) coupled between the junction of the resistors R232, R234 and circuit common. The gate of the transistor Q236 may be coupled to circuit common through a resistor R238 (e.g., which may have a resistance of approximately 22 kΩ). The gate of the transistor Q236 may receive the signal-chopper control signal V_{CHOP} from the control circuit 150. An example of the current sense circuit 260 is described in greater detail in commonly-assigned U.S. patent application Ser. No. 13/834,153, filed Mar. 15, 2013, entitled FORWARD CONVERTER HAVING A PRIMARY-SIDE CURRENT SENSE CIRCUIT, the entire disclosure of which is hereby incorporated by reference.

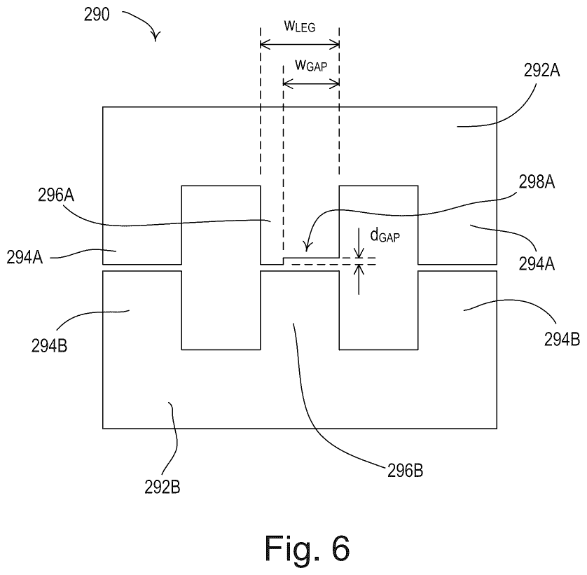

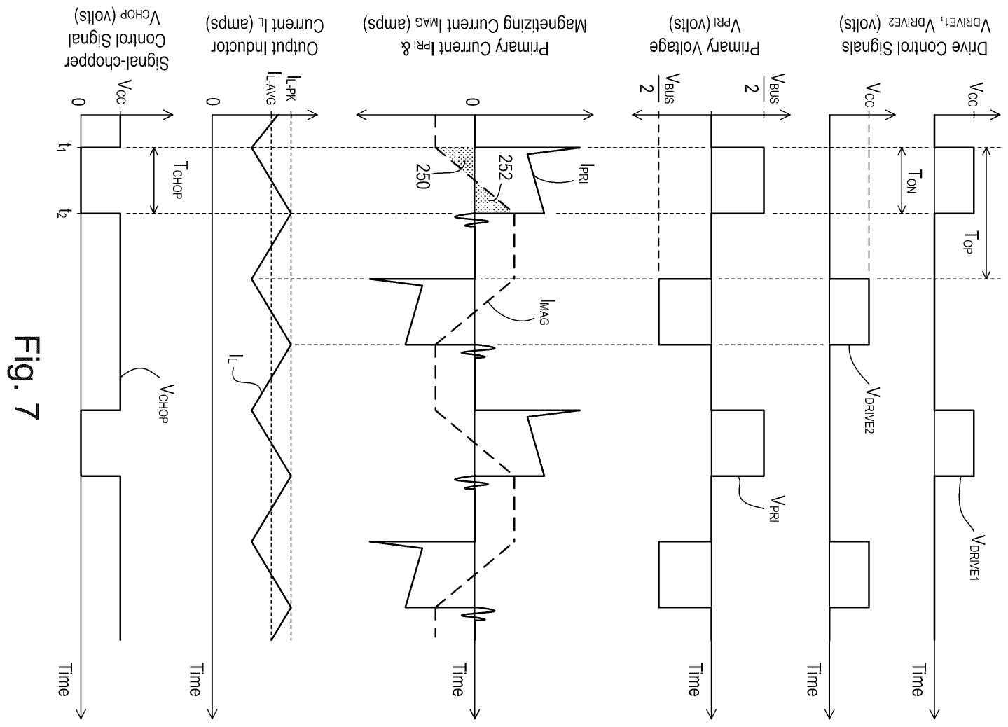

FIG. 6 is an example diagram illustrating a magnetic core set 290 of an energy-storage inductor (e.g., the output energy-storage inductor L226 of the forward converter 240 shown in FIG. 5). The magnetic core set 290 may comprise two E-cores 292A, 292B, and may comprise part number PC40EE16-Z, manufactured by TDK Corporation. The E-cores 292A, 292B may comprise respective outer legs 294A, 294B and inner legs 296A, 296B. The inner legs 296A, 296B may be characterized by a width WLEG (e.g., approximately 4 mm). The inner leg 296A of the first E-core 292A may comprise a partial gap 298A (e.g., the magnetic core set 290 may be partially-gapped), such that the inner legs 296A, 296B may be spaced apart by a gap distance d_{GAP} (e.g., approximately 0.5 mm). The partial gap 298A may extend for a gap width W_{GAP} (e.g., approximately 2.8 mm) such that the partial gap 298A may extend for approximately 70% of the leg width WLEG of the inner leg 296A. Either or both of the inner legs 296A, 296B may comprise partial gaps. The partially-gapped magnetic core set 290 (e.g., as shown in FIG. 6) may allow the output energy-storage inductor L226 of the forward converter 240 (e.g., shown in FIG. 5) to maintain continuous current at low load conditions (e.g., near the low-end intensity L_{LE}).

FIG. 7 shows example waveforms illustrating the operation of a forward converter (e.g., the forward converter 240) and a current sense circuit (e.g., the current sense circuit 260). The forward converter 240 may generate the waveforms shown in FIG. 7, for example, when operating in the normal mode and in the active state of the burst mode as described herein. As shown in FIG. 7, a control circuit (e.g., the control circuit 150) may drive the respective drive control signals V_{DRIVE1}, V_{DRIVE2} high to approximately the supply voltage V_{CC} to render the respective FETs Q210, Q212 conductive for an on time T_{ON}. The FETs Q210, Q212 may be rendered conductive at different times. When the high-side FET Q210 is conductive, the primary winding of the transformer 220 may conduct a primary current I_{PRI} to circuit common through the capacitor C216 and sense resistor R222. After (e.g., immediately after) the high-side FET Q210 is rendered conductive (at time t₁ in FIG. 7), the primary current I_{PRI} may conduct a short high-magnitude pulse of current due to the parasitic capacitance C_{P3} of the transformer 220 as shown in FIG. 7. While the high-side FET Q210 is conductive, the capacitor C216 may charge, such that a voltage having a magnitude of approximately half of the magnitude of the bus voltage V_{BUS} may be developed across the capacitor. The magnitude of the primary voltage V_{PRI} across the primary winding of the transformer 220 may be equal to approximately half of the magnitude of the bus voltage V_{BUS} (e.g., V_{BUS}/2). When the low-side FET Q212 is conductive, the primary winding of the transformer 220 may conduct the primary current I_{PRI} in an opposite direction and the capacitor C216 may be coupled across the primary winding, such that the primary voltage V_{PRI} may have a negative polarity with a magnitude equal to approximately half of the magnitude of the bus voltage V_{BUS}.

When either of the high-side and low-side FETs Q210, Q212 are conductive, the magnitude of an output inductor current I_{L} conducted by the output inductor L226 and/or the magnitude of the load voltage V_{LOAD} across the LED light source 202 may increase with respect to time. The magnitude of the primary current I_{PRI} may increase with respect to time while the FETs Q210, Q212 are conductive (e.g., after an initial current spike). When the FETs Q210, Q212 are non-conductive, the output inductor current I_{L} and the load voltage V_{LOAD} may decrease in magnitude with respective to time. The output inductor current I_{L} may be characterized by a peak magnitude I_{L-PK} and an average magnitude I_{L-AVG}, for example, as shown in FIG. 7. The control circuit 150 may increase and/or decrease the on times T_{ON} of the drive control signals V_{DRIVE1}, V_{DRIVE2} (e.g., and the duty cycle DC_{INV} of the inverter voltage V_{INV}) to respectively increase and decrease the average magnitude I_{L-AVG} of the output inductor current I_{L}, and thus respectively increase and decrease the intensity of the LED light source 202.

When the FETs Q210, Q212 are rendered non-conductive, the magnitude of the primary current I_{PRI} may drop toward zero amps (e.g., as shown at time t₂ in FIG. 7 when the high-side FET Q210 is rendered non-conductive). A magnetizing current IMAG may continue to flow through the primary winding of the transformer 220, for example, due to the magnetizing inductance L_{MAG} of the transformer. When the target intensity L_{TRGT} of the LED light source 102 is near the low-end intensity L_{LE}, the magnitude of the primary current I_{PRI} may oscillate after either of the FETs Q210, Q212 is rendered non-conductive. The oscillation may be caused by the parasitic capacitances C_{P1}, C_{P2} of the FETs, the parasitic capacitance C_{P3} of the primary winding of the transformer 220, and/or any other parasitic capacitances of the circuit (e.g., such as the parasitic capacitances of the printed circuit board on which the forward converter 240 is mounted).

The real component of the primary current I_{PRI} may indicate the magnitude of the secondary current I_{SEC} and thus the intensity of the LED light source 202. The magnetizing current I_{MAG} (e.g., the reactive component of the primary current I_{PRI}) may flow through the sense resistor R222. When the high-side FET Q210 is conductive, the magnetizing current I_{MAG} may change from a negative polarity to a positive polarity. When the low-side FET Q210 is conductive, the magnetizing current I_{MAG} may change from a positive polarity to a negative polarity. When the magnitude of the primary voltage V_{PRI} is zero volts, the magnetizing current I_{MAG} may remain constant, for example, as shown in FIG. 7. The magnetizing current I_{MAG} may have a maximum magnitude defined by the following equation:

$${I}_{M A G - M A X} = \frac{{V}_{BUS} \cdot {T}_{H C}}{4 \cdot {L}_{M A G}} ,$$

where T_{HC} may be the half-cycle period of the inverter voltage V_{INV}, e.g., T_{HC}=T_{OP}/2. As shown in FIG. 7, the areas 250, 252 may be approximately equal, such that the average value of the magnitude of the magnetizing current I_{MAG} may be zero during the period of time when the magnitude of the primary voltage V_{PRI} is greater than approximately zero volts (e.g., during the on time T_{ON} as shown in FIG. 7).

The current sense circuit 260 may determine an average of the primary current I_{PRI} during the positive cycles of the inverter voltage V_{INV}, e.g., when the high-side FET Q210 is conductive. As described herein, the high-side FET Q210 may be conductive during the on time T_{ON}. The load current feedback signal V_{I-LOAD}, which may be generated by the current sense circuit 260, may have a DC magnitude that is the average value of the primary current I_{PRI} (e.g., when the high-side FET Q210 is conductive). Because the average value of the magnitude of the magnetizing current I_{MAG} may be approximately zero during the period of time that the high-side FET Q210 is conductive (e.g., during the on time T_{ON}), the load current feedback signal V_{I-LOAD} generated by the current sense circuit may indicate the real component (e.g., only the real component) of the primary current I_{PRI} (e.g., during the on time T_{ON}).

When the high-side FET Q210 is rendered conductive, the control circuit 150 may drive the signal-chopper control signal V_{CHOP} low towards circuit common to render the transistor Q236 of the current sense circuit 260 non-conductive for a signal-chopper time T_{CHOP}. The signal-chopper time T_{CHOP} may be approximately equal to the on time T_{ON} of the high-side FET Q210, for example, as shown in FIG. 7. The capacitor C230 may charge from the sense voltage V_{SENSE} through the resistors R232, R234 while the signal-chopper control signal V_{CHOP} is low. The magnitude of the load current feedback signal V_{I-LOAD} may be the average value of the primary current I_{PRI} and may indicate the real component of the primary current during the time when the high-side FET Q210 is conductive. When the high-side FET Q210 is not conductive, the control circuit 150 may drive the signal-chopper control signal V_{CHOP} high to render the transistor Q236 conductive. Accordingly, the control circuit 150 may be able to determine the average magnitude of the load current I_{LOAD} from the magnitude of the load current feedback signal V_{I-LOAD}, at least partially because the effects of the magnetizing current I_{MAG} and the oscillations of the primary current I_{PRI} on the magnitude of the load current feedback signal V_{I-LOAD} may be reduced or eliminated.

As the target intensity L_{TRGT} of the LED light source 202 is decreased towards the low-end intensity L_{LE} and/or the on times T_{ON} of the drive control signals V_{DRIVE1}, V_{DRIVE2} get smaller, the parasitic of the load regulation circuit 140 (e.g., the parasitic capacitances C_{P1}, C_{P2} of the FETs Q210, Q212, the parasitic capacitance C_{P3} of the primary winding of the transformer 220, and/or other parasitic capacitances of the circuit) may cause the magnitude of the primary voltage V_{PRI} to slowly decrease towards zero volts after the FETs Q210, Q212 are rendered non-conductive.

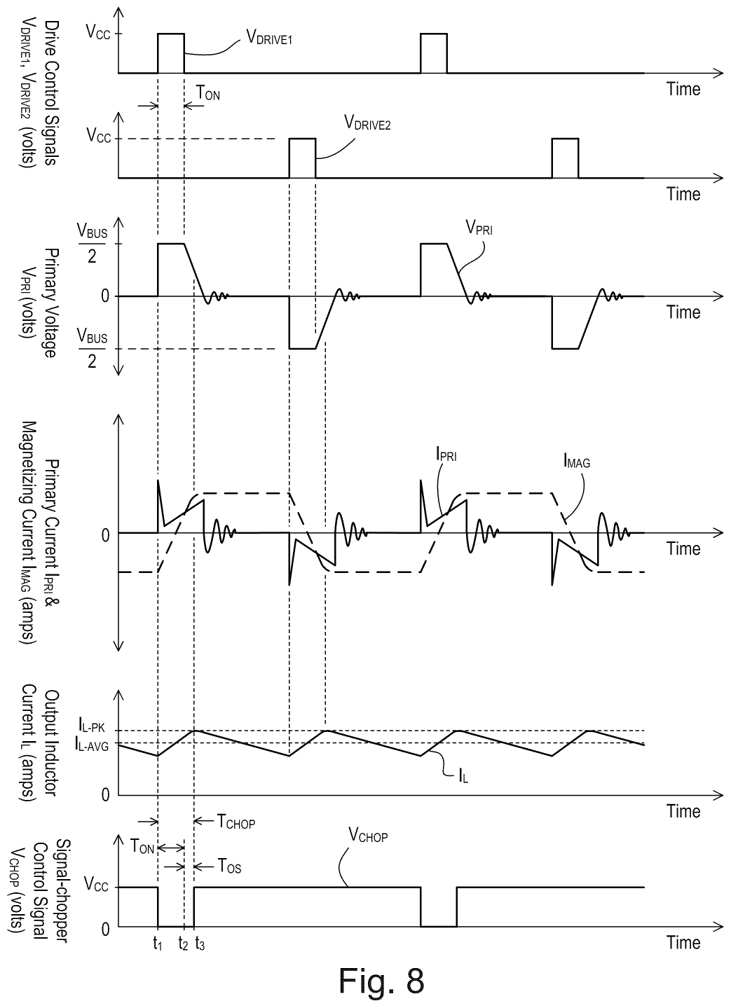

FIG. 8 shows example waveforms illustrating the operation of a forward converter and a current sense circuit (e.g., the forward converter 240 and the current sense circuit 260) when the target intensity L_{TRGT} is near the low-end intensity L_{LE}, and when the forward converter 240 is operating in the normal mode and the active state of the burst mode. The gradual drop off in the magnitude of the primary voltage V_{PRI} may allow the primary winding of the transformer 220 to continue to conduct the primary current I_{PRI}, such that the transformer 220 may continue to deliver power to the secondary winding after the FETs Q210, Q212 are rendered non-conductive, for example, as shown in FIG. 8. The magnetizing current I_{MAG} may continue to increase in magnitude after the on time T_{ON} of the drive control signal V_{DRIVE1} (e.g., and/or the drive control signal V_{DRIVE2}). The control circuit 150 may increase the signal-chopper time T_{CHOP} to be greater than the on time T_{ON}. For example, the control circuit 150 may increase the signal-chopper time T_{CHOP} (e.g., during which the signal-chopper control signal V_{CHOP} is low) by an offset time T_{OS} when the target intensity L_{TRGT} of the LED light source 202 is near the low-end intensity L_{LE}.

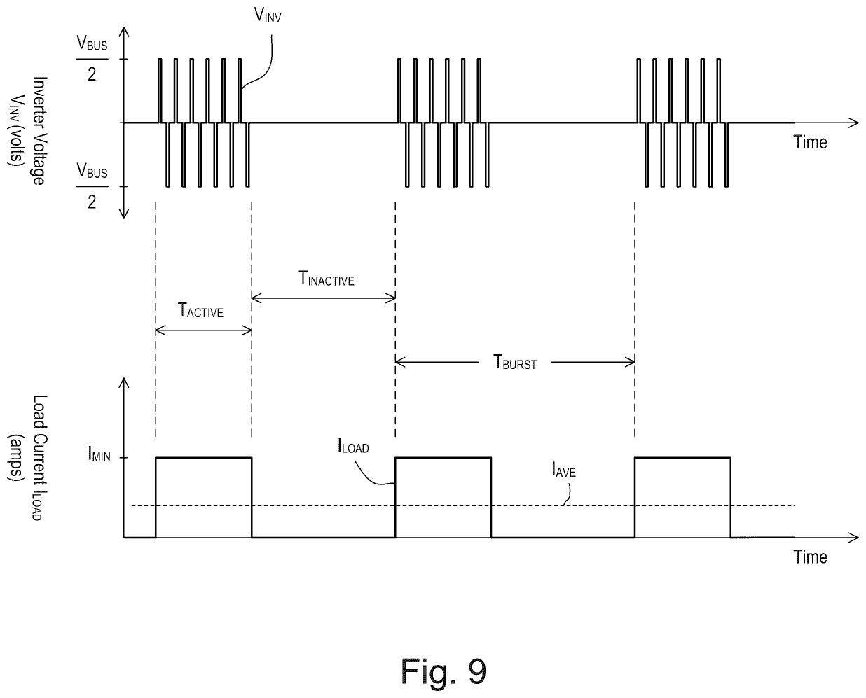

FIG. 9 shows example waveforms illustrating the operation of a forward converter (e.g., the forward converter 240 shown in FIG. 5) when operating in a burst mode. The inverter circuit of the forward converter 240 may generate the inverter voltage V_{INV} during an active state (e.g., for the duration of an active state period T_{ACTIVE}). A purpose of the inverter voltage V_{INV} may be to regulate the magnitude of the load current I_{LOAD} to the minimum rated current I_{MIN} during the active state period. During an inactive state period, the inverter voltage V_{INV} may be reduced to zero (e.g., not generated). The forward converter may enter the active state on a periodic basis with an interval approximately equal to a burst mode period T_{BURST} (e.g., approximately 4.4 milliseconds). The active state period T_{ACTIVE} and inactive state period T_{INACTIVE} may be characterized by durations that are dependent upon a burst duty cycle DC_{BURST}, e.g., T_{ACTIVE}=DC_{BURST}. T_{BURST} and T_{INACTIVE}=(1-DC_{BURST}). T_{BURST}. The average magnitude I_{AVE} of the load current I_{LOAD} may be dependent on the burst duty cycle DC_{BURST}. For example, the average magnitude I_{AVE} of the load current I_{LOAD} may be equal to the burst duty cycle DC_{BURST} times the load current I_{LOAD} (e.g., I_{AVE}=DC_{BURST}. I_{LOAD}). When the load current I_{LOAD} is equal to the minimum load current I_{MIN}, the average magnitude I_{AVE} of the load current I_{LOAD} may be equal to I_{AVE}=DC_{BURST}. I_{MIN}.

The burst duty cycle DC_{BURST} may be controlled to adjust the average magnitude I_{AVE} of the load current I_{LOAD}. The burst duty cycle DC_{BURST} may be controlled in different ways. For example, the burst duty cycle DC_{BURST} may be controlled by holding the burst mode period T_{BURST} constant and varying the length of the active state period T_{ACTIVE}. The burst duty cycle DC_{BURST} may also be controlled by holding the active state period T_{ACTIVE} constant and varying the length of the inactive state period T_{INACTIVE} (and thus varying the length of the burst mode period T_{BURST}). As the burst duty cycle DC_{BURST} is increased, the average magnitude I_{AVE} of the load current I_{LOAD} may increase. As the burst duty cycle DC_{BURST} is decreased, the average magnitude I_{AVE} of the load current I_{LOAD} may decrease. The control circuit 150 may be configured to adjust the burst duty cycle DC_{BURST} using open loop control (e.g., in response to the target intensity L_{TRGT}). The control circuit 150 may be configured to adjust the burst duty cycle DC_{BURST} using closed loop control (e.g., in response to the load current feedback signal V_{I-LOAD}).

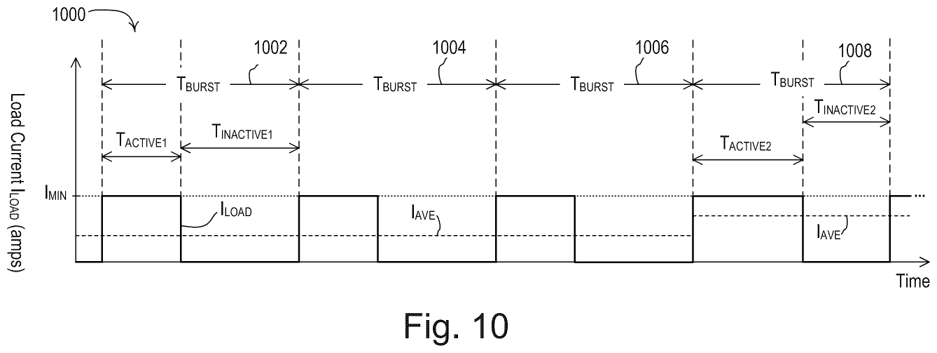

FIG. 10 shows a diagram of an example waveform 1000 illustrating the load current I_{LOAD} when a load regulation circuit (e.g., the load regulation circuit 140) is operating in a burst mode, for example, as the target intensity L_{TRGT} of a light source (e.g., the LED light source 202) is being increased (e.g., from the low-end intensity L_{LE}). A control circuit (e.g., the control circuit 150 of the LED driver 100 shown in FIG. 1 and/or the control circuit 150 controlling the forward converter 240 and the current sense circuit 260 shown in FIG. 5) may adjust the length of the active state period T_{ACTIVE} of the burst mode period T_{BURST} by adjusting the burst duty cycle DC_{BURST}. Adjusting the length of the active state period T_{ACTIVE} may adjust the average magnitude I_{AVE} of the load current I_{LOAD}, and in turn the intensity of the light source.

The active state period T_{ACTIVE} of the load current I_{LOAD} may have a length that is dependent upon the length of an inverter cycle of the inverter circuit of the load regulation circuit (e.g., the operating period TOP). For example, the active state period T_{ACTIVE} may comprise six inverter cycles, and as such, may have a length that is equal to the duration of the six inverter cycles. The control circuit may adjust (e.g., increase or decrease) the length of the active state periods T_{ACTIVE} by adjusting the number of inverter cycles in the active state period T_{ACTIVE}. As such, the control circuit may adjust the length of the active state periods T_{ACTIVE} by predetermined increments/decrements, e.g., with each increment/decrement corresponding to approximately the length of an inverter cycle (e.g., such as the transition operating period T_{OP-T}, which may be approximately 12.8 microseconds). Since the average magnitude I_{AVE} of the load current I_{LOAD} may depend on the active state period T_{ACTIVE}, the average magnitude I_{AVE} may also be adjusted by a predetermined increment/decrement that corresponds to a change in the load current I_{LOAD} resulting from the addition or removal of an inverter cycle per active state period T_{ACTIVE}.

FIG. 10 shows four burst mode periods T_{BURST} 1002, 1004, 1006, 1008 with equivalent length. The first three burst mode periods T_{BURST} 1002, 1004, 1006 may be characterized by equivalent active state periods T_{ACTIVE1} (e.g., with the same number of inverter cycles) and equivalent inactive state periods T_{INACTIVE1}. The fourth burst mode period T_{BURST} 1008 may be characterized by an active state period T_{ACTIVE2} that is larger than the active state periods T_{ACTIVE1} (e.g., by one more inverter cycle), and an inactive state period T_{INACTIVE2} that is smaller than the inactive state period T_{INACTIVE1} (e.g., by one fewer inverter cycle). The larger active state period T_{ACTIVE2} and smaller inactive state period T_{INACTIVE2} may result in a larger duty cycle and a corresponding larger average magnitude I_{AVE} of the load current I_{LOAD} (e.g., as shown during burst mode period 1008). As the average magnitude I_{AVE} of the load current I_{LOAD} increases, the intensity of the light source may increase accordingly. Hence, as shown in FIG. 10, by adding inverter cycles to or removing inverter cycles from the active state periods T_{ACTIVE} while maintaining the length of the burst mode periods T_{BURST}, the control circuit may adjust the average magnitude I_{AVE} of the load current I_{LOAD}. Such adjustments to only the active state periods T_{ACTIVE}, however, may cause changes in the intensity of the lighting load that are perceptible to the user, e.g., when the target intensity is equal to or below the transition intensity L_{TRAN}.

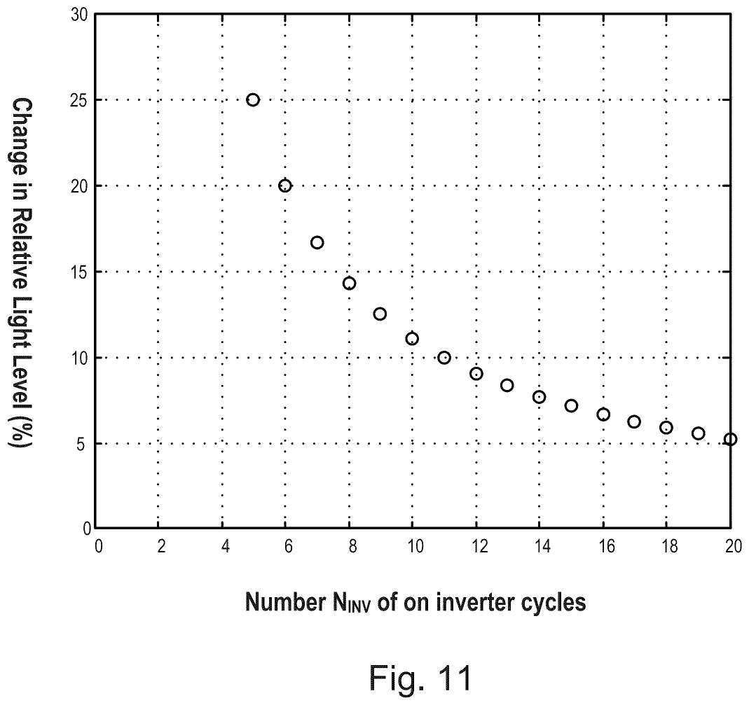

FIG. 11 illustrates how the relative average light intensity of a light source may change as a function of the number N_{INV} of inverter cycles included in an active state period T_{ACTIVE} if the control circuit only adjusts the active state periods T_{ACTIVE} during the burst mode. As described herein, T_{ACTIVE} may be expressed as T_{ACTIVE}=N_{INV}·T_{OP-LE}, wherein T_{OP-LE} may represent a low-end operating period of the relevant inverter circuit. As shown in FIG. 11, if the control circuit adjusts the length of the active state periods T_{ACTIVE} from four to five inverter cycles, the relative light intensity may change by approximately 25%. If the control circuit adjusts the length of the active state periods T_{ACTIVE} from five to six inverter cycles, the relative light intensity may change by approximately 20%.

Fine tuning of the light level or light intensity of the lighting load may be achieved by configuring the control circuit to adjust (e.g., increase or decrease) the length of the inactive state periods T_{INACTIVE} in the burst mode. Adjustments to the length of the inactive state periods T_{INACTIVE} may be made between adjusting the length of the active state periods T_{ACTIVE}. Adjustments to the length of the inactive state periods T_{INACTIVE} may also be made while adjusting the length of the active state periods T_{ACTIVE}. The adjustments to the inactive state periods T_{INACTIVE} may be made in one or more steps with respective adjustment amounts. The respective adjustment amounts may be substantially equal to or different from each other. The respective adjustment amounts may be determined such that an adjustment made to the inactive state periods will cause a same or smaller change to the light intensity (e.g., a smaller change relative to a specific light intensity level) than an adjustment to active state periods (e.g., by one inverter cycle) would have caused had the inactive state periods not been changed. In an example, one or more of the respective adjustment amounts made to the inactive state periods may be smaller than an adjustment amount made to the active state periods. In an example, the respective adjustment amounts made to the inactive state periods may not be smaller than the adjustment amount made to the active state periods, but the changes caused by the respective inactive adjustment amounts to the relative light intensity may still be smaller than the change caused by the active state adjustment amount. The control circuit may adjust the length of the inactive state periods T_{INACTIVE} as a function of the target intensity L_{TRGT} of the lighting load.

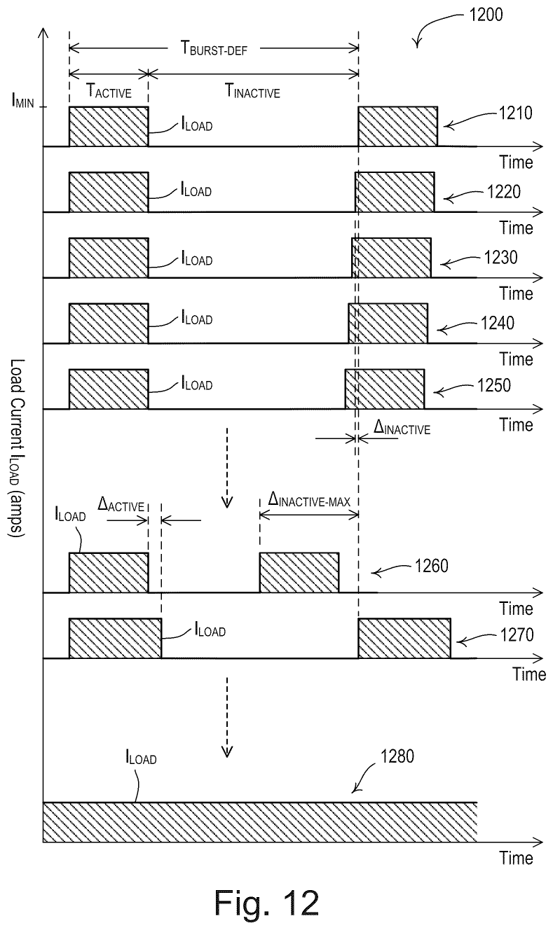

FIG. 12 shows example waveforms 1210-1280 illustrating the load current I_{LOAD} when a load regulation circuit (e.g., the load regulation circuit 140) is controlled (e.g., by the control circuit 150) to operate in the burst mode. More specifically, the illustrated example shows that the control circuit may adjust the target intensity L_{TRGT} of the light source (e.g., the LED light source 202) by first adjusting the length of the inactive state periods and then adjusting the length of the active state periods. By using the control technique shown in FIG. 12, the control circuit may accomplish fine dimming of the lighting load.

As shown in FIG. 12, the control circuit may control the load current I_{LOAD} to have a default burst mode period T_{BURST-DEF} (e.g., as shown in waveform 1210). For example, the default burst mode period T_{BURST-DEF} may be approximately 800 microseconds to correspond to a frequency of approximately 1.25 kHz. The inverter circuit comprised in the load regulation circuit may be characterized by an operating frequency for-BURST (e.g., approximately 25 kHz) and an operating period T_{OP-BURST} (e.g., approximately 40 microseconds). The control circuit may adjust the length of the inactive state periods T_{INACTIVE} gradually, for example, between adjusting the length of the active state periods T_{ACTIVE}. The adjustment to the length of the inactive state periods T_{INACTIVE} may be made in one or more steps (e.g., over one or more adjacent or separate burst mode periods) with respective inactive state adjustment amounts Δ_{INACTIVE}. The respective inactive state adjustment amounts may be substantially the same for each step or may be different for different steps, so long as the adjustments may allow fine tuning of the light intensity of the lighting load. For example, the inactive-state adjustment amount Δ_{INACTIVE} may be equal to a percentage (e.g., approximately 1%) of the default burst mode period T_{BURST-DEF} (e.g., approximately 8 microseconds).

The control circuit may adjust the length of the inactive state periods T_{INACTIVE} (e.g., by the inactive-state adjustment amount Δ_{INACTIVE} each time) while maintaining the length of the active state period T_{ACTIVE} constant (as shown in waveforms 1210-1260 in FIG. 12). When the length of the inactive state periods T_{INACTIVE} has been adjusted by a threshold amount (e.g., a maximum adjustment amount Δ_{INACTIVE-MAX}, as shown in waveform 1260), the control circuit may adjust the length of the active state periods T_{ACTIVE} by an active state adjustment amount Δ_{ACTIVE} (e.g., by one additional inverter cycle length) in a succeeding burst mode period, for example. The control circuit may adjust the length of the inactive state periods (e.g., in the same succeeding burst mode period) such that the length of the burst mode period T_{BURST} may revert back to that of the default burst mode period T_{BURST-DEF}, and the length of the inactive state periods T_{INACTIVE} may be equal to the difference between the default burst mode period T_{BURST-DEF} and the present length of the active state periods T_{ACTIVE} (as shown in waveform 1270 of FIG. 12). The control circuit may then go back to adjusting the length of the inactive state periods T_{INACTIVE} as described herein until the length of the inactive state periods T_{INACTIVE} has once again been adjusted by the maximum adjustment amount Δ_{INACTIVE-MAX}. At that point, the control circuit may adjust the length of the active state periods T_{ACTIVE} and/or the length of the inactive state periods T_{INACTIVE} such that the burst mode period T_{BURST} may again be adjusted back to the default burst mode period T_{BURST-DEF}. Eventually, the burst duty cycle DC_{BURST} may reach approximately 100% (e.g., as shown in waveform 1280) and the light intensity of the lighting load may reach the transition intensity L_{TRAN}. Beyond that point, the control circuit may begin adjusting the target load current I_{TRGT} in the normal mode (e.g., via PWM or CCR).

As described herein, the user's eyes may be more sensitive to changes in the relative light level of the lighting load when the light level is low (e.g., below to the transition intensity L_{TRAN}). The maximum adjustment amount Δ_{INACTIVE-MAX} for the inactive state periods T_{INACTIVE} may be sized to reduce perceptible changes in the relative light level of the lighting load. For example, if the lengths of the active state periods T_{ACTIVE} and the inactive state periods T_{INACTIVE} are both adjusted (e.g., between waveforms 1260 and 1270 in FIG. 12), a properly sized maximum adjustment amount Δ_{INACTIVE-MAX} may enable a smooth transition from a current intensity level into the next intensity level. The maximum adjustment amount Δ_{INACTIVE-MAX} may be determined as a function of the present length of the active state period T_{ACTIVE} (e.g., the number of inverter cycles included in the active state period T_{ACTIVE}). The determination may be made by calculating a value for the maximum adjustment amount Δ_{INACTIVE-MAX} in real-time or by retrieving a predetermined value from memory (e.g., from a lookup table). In an example, when the active state period T_{ACTIVE} presently includes four inverter cycles, the maximum adjustment amount Δ_{INACTIVE-MAX} may be approximately equal to the change in the relative light level when the length of the active state period T_{ACTIVE} changes from four to five inverter cycles (e.g., 25% as shown in FIG. 11). In another example, the maximum adjustment amount Δ_{INACTIVE-MAX} may be approximately equal to the burst operating period T_{OP-BURST} of the inverter circuit (e.g., approximately 40 microseconds). The control circuit may store the value of the maximum adjustment amount Δ_{INACTIVE-MAX} in memory (e.g., in a lookup table)

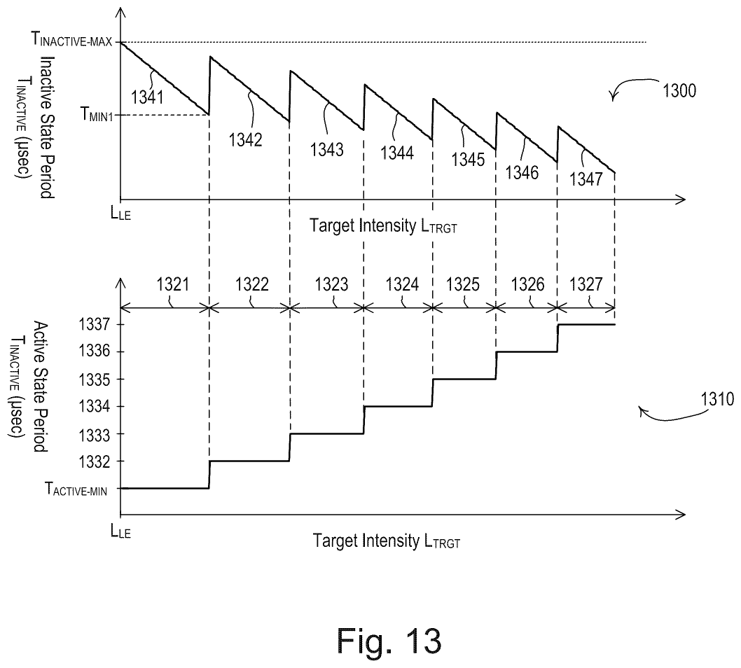

FIG. 13 shows two example plot relationships depicting how a target light intensity of the lighting load may change in accordance with changes in the lengths of the active and inactive state periods when a load regulation circuit (e.g., the load regulation circuit 140) is controlled (e.g., by the control circuit 150) to operate in the burst mode. Plot 1300 shows an example relationship between the length of the inactive state period T_{INACTIVE} and the target intensity L_{TRGT} of the lighting load. Plot 1310 shows an example relationship between the length of the active state period T_{ACTIVE} and the target intensity L_{TRGT} of the lighting load. The length of the active state period T_{ACTIVE} may be expressed in time terms or in terms of the number of inverter cycles N_{INV} included in the active state period T_{ACTIVE}, for example.

As described herein, the control circuit (e.g., the control circuit 150 of the LED driver 100 shown in FIG. 1 and/or the control circuit 150 controlling the forward converter 240 and the current sense circuit 260 shown in FIG. 5) may determine the magnitude of the target load current I_{TRGT} and/or the burst duty cycle DC_{BURST} based on the target intensity L_{TRGT}. The control circuit may determine the target intensity L_{TRGT}, for example, via a digital message received via the communication circuit 180, via a phase-control signal received from a dimmer switch, and/or the like. The target intensity L_{TRGT} may be constant or may be changing (e.g., fading) from one intensity level to another. The control circuit may determine the length of the active state period T_{ACTIVE} based on the target intensity L_{TRGT}. After determining the length of the active state period T_{ACTIVE}, the control circuit may determine the length of the inactive state period T_{INACTIVE} that may be used with the present active state period T_{ACTIVE} such that the light source may be driven to the target intensity L_{TRGT}. The control circuit may determine the lengths of the active state period T_{ACTIVE} and/or the inactive state period T_{INACTIVE} by calculating the values in real-time and/or retrieving the values from memory (e.g., via a lookup table or the like).

Referring to FIG. 13, if the control circuit determines that the target intensity L_{TRGT} falls within the range 1321, then the control circuit may determine to set the burst mode period to a default burst mode period (e.g., such as T_{BURST-DEF}, which may be approximately 800 microseconds) and the active state period T_{ACTIVE} to a minimum active state period T_{ACTIVE-MIN} (e.g., including four inverter cycles). The control circuit may determine to set the inactive state period T_{INACTIVE} according to the profile 1341, which may range from a maximum inactive state period T_{INACTIVE-MAX} to a minimum inactive state period T_{MIN1}. The maximum inactive state period T_{INACTIVE-MAX} may be determined based on the length of the present burst operating period (e.g., the default burst mode period T_{BURST-DEF}) and/or the length of the present active state period T_{ACTIVE-MIN}. The minimum inactive state period T_{MIN1} may be determined based on the maximum inactive state adjustment amount Δ_{INACTIVE-MAX}, which may in turn be dependent upon the length of the present active state period T_{ACTIVE-MIN}. The gradient of the profile 1341 may be determined based on the size of an inactive state adjustment step (e.g., such as the inactive state adjustment amount Δ_{INACTIVE}), which, may be equal to a percentage (e.g., approximately 1%) of the default burst mode period T_{BURST-DEF}, for example. As noted herein, the control circuit may determine the lengths of the active state period T_{ACTIVE} and/or the inactive state period T_{INACTIVE} by calculating the values in real-time and/or retrieving the values from memory.

If the control circuit determines that the target intensity L_{TRGT} falls within the range 1322, then the control circuit may determine to set the active state period T_{ACTIVE} to 1332. The active state period 1332 may be greater than the minimum active state period T_{ACTIVE-MIN}. For example, the active state period 1332 may include one more inverter cycle than the minimum active state period T_{ACTIVE-MIN}. The control circuit may determine to set the inactive state period T_{INACTIVE} according to the profile 1342. In an example, the starting point of the profile 1342 may be dependent upon the length of the present burst cycle period (e.g., the default burst cycle period T_{BURST-DEF}) and the length of the present active state period 1332. The ending point of the profile 1342 may be dependent upon the maximum inactive state adjustment amount Δ_{INACTIVE-MAX}, which may in turn be dependent upon the length of the present active state period 1332. The gradient of the profile 1342 may be determined based on the size of an inactive-state adjustment step (e.g., such as the inactive-state adjustment amount Δ_{INACTIVE}), which, as noted herein, may be equal to a percentage (e.g., approximately 1%) of the default burst mode period T_{BURST-DEF}. Similarly, if the control circuit determines that the target intensity L_{TRGT} falls within one of the target intensity ranges 1323-1327, then the control circuit may determine to set the active state period T_{ACTIVE} to one of 1333-1337 and determine to set the inactive state period T_{INACTIVE} according to one of the profiles 1343-1347, respectively.

The profiles 1341-1347 may be linear or non-linear, and may be continuous (e.g., as shown in FIG. 13) or comprise discrete steps. The minimum inactive state periods for the profiles 1341-1347 may be dependent upon the present maximum adjustment amount Δ_{INACTIVE-MAX}, which may in turn be dependent upon the length of the respective active state period T_{ACTIVE}. The maximum adjustment amount Δ_{INACTIVE-MAX} of the inactive state period T_{INACTIVE} may be sized to reduce perceptible changes in the relative light level of the lighting load. In an example, the profiles 1341-1347 may be configured such that when the lengths of the active state period T_{ACTIVE} and the inactive state period T_{INACTIVE} are both adjusted (e.g., between waveforms 1260 and 1270 as shown in FIG. 12), the waveform characterized by the greater target intensity may generate a greater light output of the lighting load. In such an example, there may be slight steps up in the actual light output of the lighting load when the lengths of the active state period T_{ACTIVE} and the inactive state period T_{INACTIVE} are both adjusted (e.g., between waveforms 1260 and 1270 as shown in FIG. 12).

The graphs 1300, 1310 may represent a portion of the target intensity range between the low-end intensity L_{LE} and the transition intensity L_{TRAN} or the entire target intensity range between the low-end intensity L_{LE} and the transition intensity L_{TRAN}. More or less than seven active state periods T_{ACTIVE} (e.g., T_{ACTIVE-MIN} through 1337) may be provided between the low-end intensity L_{LE} and the transition intensity L_{TRAN}.

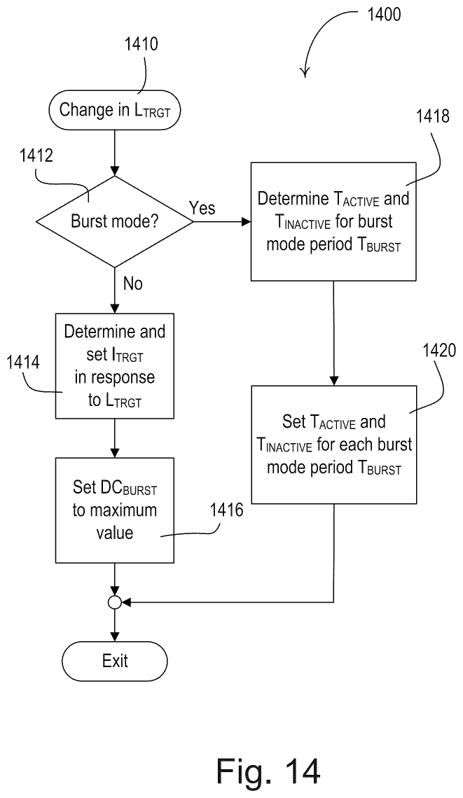

FIG. 14 illustrates an example target intensity procedure 1400 that may be executed by the control circuit described herein (e.g., the control circuit 150 of the LED driver 100 shown in FIG. 1 and/or the control circuit 150 controlling the forward converter 240 and the current sense circuit 260 shown in FIG. 5). For example, the target intensity procedure 1400 may be executed when the target intensity L_{TRGT} is adjusted at 1410 (e.g., in response to digital messages received via the communication circuit 180). The control circuit may determine if it is operating the load regulation circuit in the burst mode at 1412 (e.g., the target intensity L_{TRGT} is between the low-end intensity L_{LE} and the transition intensity L_{TRAN}, Or L_{LE}≤ L_{TRGT}≤ L_{TRAN}). If the control circuit determines that it is not operating the load regulation circuit in the burst mode (e.g., but rather in the normal mode), then the control circuit may determine and set the target load current I_{TRGT} as a function of the target intensity L_{TRGT} at 1414 (e.g., as shown in FIG. 2). The control circuit may then set the burst duty cycle DC_{BURST} equal to a maximum duty cycle DC_{MAX} (e.g., approximately 100%) at 1415 (e.g., as shown in FIG. 3), and the control circuit may exit the target intensity procedure 1400.

If the control circuit determines that it is operating the load regulation circuit in the burst mode at 1412 (e.g., the target intensity L_{TRGT} is below the transition intensity L_{TRAN}, or L_{TRGT}<L_{TRAN}), then the control circuit may determine the lengths of the active state period T_{ACTIVE} and/or the inactive state period T_{INACTIVE} for one or more burst mode periods T_{BURST} (e.g., using open loop control) at 1418. For example, the control circuit may determine target lengths of the active state period T_{ACTIVE} and the inactive state period T_{INACTIVE} that correspond to the target intensity L_{TRGT}. The control circuit may then determine the lengths of the active state period T_{ACTIVE} and/or the inactive state period T_{INACTIVE} for one or more burst mode periods. As described herein, the length of the inactive state period may be gradually adjusted (e.g., gradually increased or decreased) in one or more burst mode periods until a maximum amount of adjustment is reached. The length of the active state period may then be adjusted in a subsequent burst mode period. The determination process may be repeated in the manner described herein until the target lengths of the active state period T_{ACTIVE} and inactive state period T_{INACTIVE} are achieved.

The control circuit may perform the foregoing process by calculating the relevant values in real-time or retrieving the values from memory (e.g., via a lookup table or the like). The control circuit may set the lengths of the active state period T_{ACTIVE} and/or the inactive state period T_{INACTIVE} for the one or more burst mode periods T_{BURST} at 1420, and the control circuit may exit the target intensity procedure 1400. As described herein, the control circuit may adjust the active state period T_{ACTIVE} and/or the inactive state period T_{INACTIVE} as a function of the target intensity L_{TRGT} using open loop control. Other ways to adjust the active state period T_{ACTIVE} and/or the inactive state period T_{INACTIVE} may be employed, including, for example, using closed loop control (e.g., in response to the load current feedback signal V_{I-LOAD}).

One or more of the embodiments described herein (e.g., as performed by a load control device) may be used to decrease the intensity of a lighting load and/or increase the intensity of the lighting load. For example, one or more embodiments described herein may be used to adjust the intensity of the lighting load from on to off, off to on, from a higher intensity to a lower intensity, and/or from a lower intensity to a higher intensity. For example, one or more of the embodiments described herein (e.g., as performed by a load control device) may be used to fade the intensity of a light source from on to off (e.g., the low-end intensity L_{LE} may be equal to 0%) and/or to fade the intensity of the light source from off to on.

Although described with reference to an LED driver, one or more embodiments described herein may be used with other load control devices. For example, one or more of the embodiments described herein may be performed by a variety of load control devices that are configured to control of a variety of electrical load types, such as, for example, a LED driver for driving an LED light source (e.g., an LED light engine); a screw-in luminaire including a dimmer circuit and an incandescent or halogen lamp; a screw-in luminaire including a ballast and a compact fluorescent lamp; a screw-in luminaire including an LED driver and an LED light source; a dimming circuit for controlling the intensity of an incandescent lamp, a halogen lamp, an electronic low-voltage lighting load, a magnetic low-voltage lighting load, or another type of lighting load; an electronic switch, controllable circuit breaker, or other switching device for turning electrical loads or appliances on and off; a plug-in load control device, controllable electrical receptacle, or controllable power strip for controlling one or more plug-in electrical loads (e.g., coffee pots, space heaters, other home appliances, and the like); a motor control unit for controlling a motor load (e.g., a ceiling fan or an exhaust fan); a drive unit for controlling a motorized window treatment or a projection screen; motorized interior or exterior shutters; a thermostat for a heating and/or cooling system; a temperature control device for controlling a heating, ventilation, and air conditioning (HVAC) system; an air conditioner; a compressor; an electric baseboard heater controller; a controllable damper; a humidity control unit; a dehumidifier; a water heater; a pool pump; a refrigerator; a freezer; a television or computer monitor; a power supply; an audio system or amplifier; a generator; an electric charger, such as an electric vehicle charger; and an alternative energy controller (e.g., a solar, wind, or thermal energy controller). A single control circuit may be coupled to and/or adapted to control multiple types of electrical loads in a load control system.

1. A load control device for controlling an amount of power delivered to light-emitting diode (LED) lighting load, the load control device comprising:
a load regulation circuit that includes an inverter circuit; and
a control circuit configured to:
cause the inverter circuit to transition between:
an active state period during which the inverter circuit is active; and
an inactive state period during which the inverter circuit is inactive;
receive a target intensity input indicative of a target intensity of an operatively coupled LED lighting load;
determine a target load current based on the received target intensity input;
determine whether the target load current is at or below a threshold load current; and
responsive to the determination that the target load current is at or below the threshold load current, cause the load regulation circuit to operate in a burst mode that includes a plurality of burst mode periods;
wherein each of the burst mode periods includes at least one active state period and at least one inactive state period; and
wherein, for at least some of the burst mode periods, the control circuit adjusts a burst duty cycle by varying the duration of the at least one inactive state period while fixing the duration of the at least one active state period.

2. The load control device of claim 1 wherein to adjust the burst duty cycle by varying the duration of the at least one inactive state period while fixing the duration of the at least one active state period constant, the control circuit to further:
adjust the burst duty cycle by varying the duration of the at least one inactive state period while fixing the duration of the at least one active state period using open loop control.

3. The load control device of claim 1 wherein the control circuit to further:
determine whether the target load current is above the threshold load current; and
responsive to the determination that the target load current is above the threshold load current, cause the load regulation circuit to operate in a normal mode to provide a constant active state period, a constant inactive state period, and an adjustable target load current to the LED lighting load.

4. The load control device of claim 3 wherein the control circuit to further:
receive at least one feedback signal from the load regulation circuit;
wherein the at least one feedback signal indicative of an average load current provided to the LED lighting load; and
adjust the target load current based on the received at least one feedback signal using closed loop control.

5. A load control method to control an amount of power delivered to light-emitting diode (LED) lighting load, the method comprising:
causing, by an LED lighting controller, an inverter circuit included in a load regulation circuit operatively coupled to the LED lighting controller to transition between:
an active state period during which the inverter circuit is active; and
an inactive state period during which the inverter circuit is inactive;
receiving, by the LED lighting controller, a target intensity input indicative of a target intensity of an operatively coupled LED lighting load;
determining, by the LED lighting controller, a target load current based on the received target intensity input;
determining, by the LED lighting controller, whether the target load current is at or below a threshold load current; and
responsive to the determination that the target load current is at or below the threshold load current:
causing, by the LED lighting controller, the load regulation circuit to operate in a burst mode that includes a plurality of burst mode periods, wherein each of the burst mode periods includes at least one active state period and at least one inactive state period; and
adjusting, by the LED lighting controller, a burst duty cycle by varying the duration of the at least one inactive state period while fixing the duration of the at least one active state period.

6. The method of claim 5 wherein adjusting the burst duty cycle by varying the duration of the at least one inactive state period while fixing the duration of the at least one active state period constant, the control circuit to further:
varying, by the LED lighting controller, the duration of the at least one inactive state period while fixing the duration of the at least one active state period using open loop control.

7. The method of claim 6, further comprising:
determining, by the LED lighting controller, whether the target load current is above the threshold load current; and
responsive to the determination that the target load current is above the threshold load current:
causing, by the LED lighting controller, the load regulation circuit to operate in a normal mode to provide a constant active state period, a constant inactive state period; and
causing, by the LED lighting controller, the load regulation circuit to adjust the target load current to the LED lighting load.

8. The method of claim 7 wherein causing the load regulation circuit to adjust the target load current to the LED lighting load further comprises:
receiving, by the LED lighting controller, at least one feedback signal indicative of an average load current provided to the LED lighting load from the load regulation circuit; and
causing, by the LED lighting controller, the load regulation circuit to adjust the target load current based on the received at least one feedback signal using closed loop control.

9. A non-transitory, machine-readable, storage device that includes instructions that, when executed by an light-emitting diode (LED) lighting controller, cause the LED lighting controller to:
cause an inverter circuit included in a load regulation circuit operatively coupled to the LED lighting controller to transition between:
an active state period during which the inverter circuit is active; and
an inactive state period during which the inverter circuit is inactive;
receive a target intensity input indicative of a target intensity of an operatively coupled LED lighting load;
determine a target load current based on the received target intensity input;
determine whether the target load current is at or below a threshold load current; and
responsive to the determination that the target load current is at or below the threshold load current:
cause the load regulation circuit to operate in a burst mode that includes a plurality of burst mode periods, wherein each of the burst mode periods includes at least one active state period and at least one inactive state period; and
adjust a burst duty cycle by varying the duration of the at least one inactive state period while fixing the duration of the at least one active state period.

10. The non-transitory, machine-readable, storage device of claim 9 wherein the instructions that cause the LED lighting controller to adjust the burst duty cycle by varying the duration of the at least one inactive state period while fixing the duration of the at least one active state period constant further cause the LED lighting controller to:
vary the duration of the at least one inactive state period while fixing the duration of the at least one active state period using open loop control.

11. The non-transitory, machine-readable, storage device of claim 10 wherein the instructions, when executed by the LED lighting controller, further cause the LED lighting controller to:
determine whether the target load current is above the threshold load current; and
responsive to the determination that the target load current is above the threshold load current:
cause the load regulation circuit to operate in a normal mode to provide a constant active state period, a constant inactive state period; and
cause the load regulation circuit to adjust the target load current to the LED lighting load.

12. The non-transitory, machine-readable, storage device of claim 11 wherein the instructions that cause the LED lighting controller to cause the load regulation circuit to adjust the target load current to the LED lighting load further cause the LED lighting controller to:
receive at least one feedback signal indicative of an average load current provided to the LED lighting load from the load regulation circuit; and
cause the load regulation circuit to adjust the target load current based on the received at least one feedback signal using closed loop control.
